(19) United States
(12) Patent Application Publication
(10) Pub. No.: US 2015/0043911 A1
(43) Pub. Date: Feb. 12, 2015

(54) Network Depth Limited Network Followed by Compute Load Balancing Procedure for Embedding Cloud Services in Software-Defined Flexible-Grid Optical Transport Networks

(71) Applicant: NEC LABORATORIES AMERICA, INC., Princeton, NJ (US)

(72) Inventors: Ankitkumar N. Patel, East Brunswick, NJ (US); Philip Nan Ji, Cranbury, NJ (US)

(73) Assignee: NEC LABORATORIES AMERICA, INC., Princeton, NJ (US)

(21) Appl. No.: 14/449,250

(22) Filed: Aug. 1, 2014

Related U.S. Application Data
(60) Provisional application No. 61/863,003, filed on Aug. 7, 2013.

(51) Int. Cl. H04L 12/24; H04J 14/02; H04L 12/803; H04Q 11/00

(52) U.S. Cl. CPC H04L 41/0893; H04Q 11/0066; H04J 14/0257; H04L 47/125; H04Q 2011/0086; H04Q 2011/0079
USPC 398/48

(57) ABSTRACT

A Network Depth Limited Network Followed by Compute Load Balancing (ND-NCLB) can embed more cloud demands than the existing solutions. The inventive ND-NCLB, partitions the physical network into many sub-networks, and limits the mapping of cloud demands within one of the sub-networks to avoid over provisioning of resources.

### RELATED APPLICATION INFORMATION

This application claims priority to provisional application No. 61/863,003 filed Aug. 7, 2013, entitled “Network Depth Limited Network Followed by Compute Load Balancing Procedure for Embedding Cloud Services in Software-Defined Flexible-Grid Optical Transport Networks”, the contents thereof are incorporated herein by reference

### BACKGROUND OF THE INVENTION

The present invention relates generally to optics, and more particularly, to network depth limited network followed by compute load balancing procedure for embedding cloud services in software-defined flexible-grid optical transport networks.

The following references discuss prior efforts in the decoding:

[NMcKeown] N. McKeown, T. Anderson, H. Balakrishnan et. al, “OpenFlow: Enabling Innovation in Campus Networks,” Proc. of ACM SIGCOMM, vol. 38, issue. 2, pp. 69-74, April 2008.

[APatel] A. N. Patel, P. N. Ji, and T. Wang, “QoS-Aware Optical Burst Switching in OpenFlow-based Software-Defined Optical Networks,” Proc. of ONDM, pp. 274-279, Apr 2013.

[Ph] P. Ji, “Software Defined Optical Networks,” Proc. of ICOCN, pp.31-34, Nov. 2012.

[MYu] M. Yu, Y. Yi, J. Rexford, and M. Chiang, “Rethinking Virtual Network Embedding: Substrate Support for Path Splitting and Migration,” Proc. of ACM SIGCOMM, vol. 38, issue 2, pp. 17-29, Mar 2008.

[NMosharaf] N. M. Mosharaf, M. R. Rahman, and R. Boutaba, “Virtual Network Embedding with Coordinated Node and Link Mapping,” Proc. of INFOCOM, pp 783-791, 2009.

[SPeng] S. Peng, R. Nejabati, and D. Simeonidou, “Impairment-Aware Optical Network Virtualization in Single Line Rate and Mixed Line Rate WDM Networks,” Journal of Optical Communications and Networking, vol. 5, issue 4, pp 283-293, 2013.

[APate12] A. Patel, P. Ji, Y. Huang, and T. Wang, “Distance-Adaptive Virtual Network Embedding in Software-Defined Optical Networks,” Proc. of CLEO-PR & OECC/PS, no. WQ3-2, 2013.

Software-Defined Network (SDN) architecture [NMcKeown] enables network programmability to support multi-vendor, multi-technology, multi-layer communications, and to offer an infrastructure as a service. Recently, efforts are going on to integrate optical transport [APatel] [PJi] within IP/Ethernet-based SDN architecture to leverage optical transmission benefits, such as low interference, long reach , and high capacity transmission with lower power consumption. Such a network is referred to as Optical Transport SDN. Optical transport SDN can be realized by enabling flexibility and programmability in transmission and switching network elements, such as transponders and ROADMs, management of optical channels, such as flexible-grid channel mapping, and extracting control plane intelligence from the physical hardware to the centralized controller.

FIG. 1 shows architecture for optical transport SDN in which control plane is abstracted from physical hardware of network elements and most network control and management intelligence now resides into a centralized controller. The centralized controller controls network elements using a standardized protocol, such as OpenFlow [NMcKeown] over standardized interfaces at controller and network elements. The control plane decisions present in the form of rules, actions, and policies, and network elements applies these decision based on match-action on connections. Thus, optical transport SDN partitions a network into software defined optics (SDO) and optics defined controller (ODC).

Software-defined optics consists of variable rate transponders, flexible-grid channel mapping, and colorless-directionless-contentionless-gridless (CDCG) ROADMs. Variable-rate transponder can be programmed for various modulation formats and FEC coding. Thus, transponders can offer variable transmission capacity for heterogeneous reach requirements. Flexible-grid channel mapping allows an assignment of flexible amount of spectrum to channels to achieve higher spectral efficiency by applying spectrum-efficient modulation formats and eliminating guard bands. CDCG-ROADM can be programmed to switch connections operating on any wavelength with any spectral requirement over any outgoing direction. Furthermore, connections can be added and dropped at a node without contentions. These hardware and their features establishes foundation of SDON optimization and customization capabilities.

Optics defining controller manages the network, and performs network optimization and customization to utilize flexibility of SDO. ODC functionalities are further extracted into network/compute hypervisor, operating system, network applications and database, and debugger and management planes. These planes are isolated by open standardized interfaces to allow simultaneous and rapid innovations at each layer independently. Various control plane functionalities, for example, cloud resource mapping, routing and resource allocation, protection and restoration, defragmentation, energy optimization, etc., are installed as applications and data base in the ODC. Network/compute hypervisor offers virtualization by providing isolation and sharing functions to a data plane as well as an abstract view of network and computing resources while hiding physical layer implementation details to a controller in order to optimize and simplify the network operations. Operating system offers a programmable platform for the execution of applications and hypervisors. Debugger and management plane offers access control and QoS management, while monitoring network performance, and performs fault isolation, localization, and recovery.

Recently, cloud services have gained a lot of interests since it supports applications by sharing resources within existing deployed infrastructure instead of building new ones from scratch. These days network applications are becoming more and more cloud centric, for example social networking applications, such as FaceBook, Twitter, and Google+, e-science applications, such as Large Hadron Collider, content applications, such as NetFlix, and search applications, such as Google and Baidu. Cloud applications are supported by interconnecting various computing, storage, software, and platform-oriented resources within data centers through networks. Each data center is built with the goal of optimizing the type of services offered, for example Google data center is built with the goal of efficient indexing of web pages and minimization of content search time, while Facebook data center is built to offer maximum storage for user contents and efficient management and linking of these contents within user's social group, Amazon EC2 data center is built to offer faster computing time. Thus, one data center may not provide all types of resource, and may not optimally meet all the requirements of a cloud application. In such scenarios, open challenges are how to map a cloud request among data centers offering heterogeneous resources, and how to establish network connectivity between data centers. The problem is referred to as cloud service embedding problem. In this invention, we investigate cloud service embedding problem over software-defined flexible grid transport SDN networks. The problem is formally defined as follow.

We are given a physical network topology G(N, L), where N represents a set of physical nodes (PNs) and L represents a set of physical links (PLs) interconnecting physical nodes. Each node offers different types resources, for example, 1, 2, 3, . . . , n, and the number of offered resources Cⱼⁿ for each type j is given in advance. A node also consists of CDCG-ROADMs and variable rate transponders. CDCG-ROADM offers switching of flex-grid optical connections while variable rate transponders offer a set of modulation formats M, where the spectral efficiency Zₘ bit/second/Hz and transmission reach Dₘ Km of each modulation format m is also given. A fiber offers total T THz of spectrum. A cloud demand is defined as G′(V, E, C, L), where V is a set of virtual nodes (VNs), E is a set of virtual links (VLs) connecting virtual nodes, C is a set of requested resources (Cᵢ¹, Cᵢ², . . . , Cᵢⁿ) at each virtual node i, L is a set of requested line rate lᵢⱼ between virtual nodes i and j. The arrival and departure distributions of cloud requests are given. The problem is how to map virtual nodes of a cloud demand over physical nodes (the virtual node embedding problem) and virtual links of a cloud demand over physical links (the virtual link embedding problem), such that the number of embedded cloud demands is maximized. Virtual link embedding problem consists of sub-problems such as how to route a virtual link over physical routes, how to assign a wavelength and allocate spectrum, and how to select a modulation format. It is assumed that a network does not support wavelength, spectrum, or modulation format conversion capability.

Cloud embedding mainly consists of virtual node embedding and virtual link embedding. Since physical node and link resources are shared among multiple could demands, an embedding procedure needs to ensure isolation of these resources while maintaining the resource capacity constraints. When mapping virtual nodes over physical nodes, a procedure needs to ensure that different virtual nodes cannot be mapped over the same physical node. When mapping virtual links over physical routes through optical channels in flex-grid transport SDN, a procedure needs to ensure the wavelength continuity, and spectral continuity, spectral conflict. The wavelength continuity constraint is defined as an allocation of spectrum at the same operating wavelength on all links along the route of an optical channel. The spectral continuity constraint is defined as an allocation of the same amount of spectrum on all links along the route of an optical channel. The spectral conflict constraint is defined as an allocation of non-overlapping spectrum to all channels routed through the same fiber. Furthermore, a procedure also needs to make sure that a selection of modulation format for a virtual link and its routing over the network should support at least the physical Euclidean distance between the physical nodes on which virtual nodes are mapped. The constraint is referred to as the reachability constraint.

Cloud service embedding consists of virtual node embedding and virtual link embedding sub-problems. If the virtual nodes are per-assigned to physical nodes, then the problem of just mapping virtual links over physical links is referred to as virtual network embedding problem. The virtual network embedding problems have been extensively solved for IP/Ethernet-based networks [MYu] [NMosharaf] while ignoring optical transport. Recently, in [SPeng] and [APatel2], the virtual network embedding problem is solved for fixed grid and flexible grid optical transport networks respectively.

Accordingly, there is a need for cloud embedding services procedure that overcomes problems with prior efforts.

### BRIEF SUMMARY OF THE INVENTION

The invention is directed a computer implemented method for embedding cloud demands over a software defined flexible grid optical transport network. The method includes partitioning a software defined flexible grid optical transport network into multiple sub-networks; a sub-network being selected among a set of the sub-networks with a depth d in a descending order of a maximum average ration of available computing resources to a total offered resources in the network, the network depth being a maximum number of hops from a center node to any node in the network, mapping a cloud demand over of the sub-networks using as load balancing that slots spectrum in the network into wavelength slots for reducing complexity of the mapping; and increasing network depth d to increase a sub-network size until the cloud demand is successfully provisioned over the sub-network.

In a similar aspect of the invention, there is provided a non-transitory storage medium configured with A non-transitory storage medium configured with instructions to be implemented by a computer for carrying out partitioning a software defined flexible grid optical transport network into multiple sub-networks, a sub-network being selected among a set of the sub-networks with a depth d in a descending order of a maximum average ratio of available computing resources to a total offered resources in the network, the network depth being a maximum number of hops from a center node to any node in the network. mapping a cloud demand over of the sub-networks using as load balancing that slots spectrum in the network into wavelength slots for reducing complexity of the mapping, and increasing network depth d to increase a sub-network size until the cloud demand is successfully provisioned over the sub-network.

In a yet further similar aspect of the invention there is provided a system for a computer implemented method for embedding cloud demands over a software defined flexible grid optical transport network including partitioning a software defined flexible grid optical transport network into multiple sub-networks; a sub-network being selected among a set of the sub-networks with a depth d in a descending order of a maximum average ratio of available computing resources to a total offered resources in the network, the network depth being a maximum number of hops from a center node to any node in the network, mapping a cloud demand over of the sub-networks using as load balancing that slots spectrum in the network into wavelength slots for reducing complexity of the mapping; and increasing network depth d to increase a sub-network size until the cloud demand is successfully provisioned over the sub-network.

These and other advantages of the invention will be apparent to those of ordinary skill in the art by reference to the following detailed description and the accompanying drawings.

### BRIEF DESCRIPTION OF THE DRAWINGS

FIG. 1 is a diagram depicting architecture of an optical transport software defined network SDN.

FIG. 2 is a flow chart of the network depth limited network followed by compute load balancing ND-NCLB, in accordance with the invention.

FIG. 3 is a flow chart of the network compute load balancing NCLB, in accordance with the invention.

FIG. 4 shows an exemplary computer to perform the inventive NCLB.

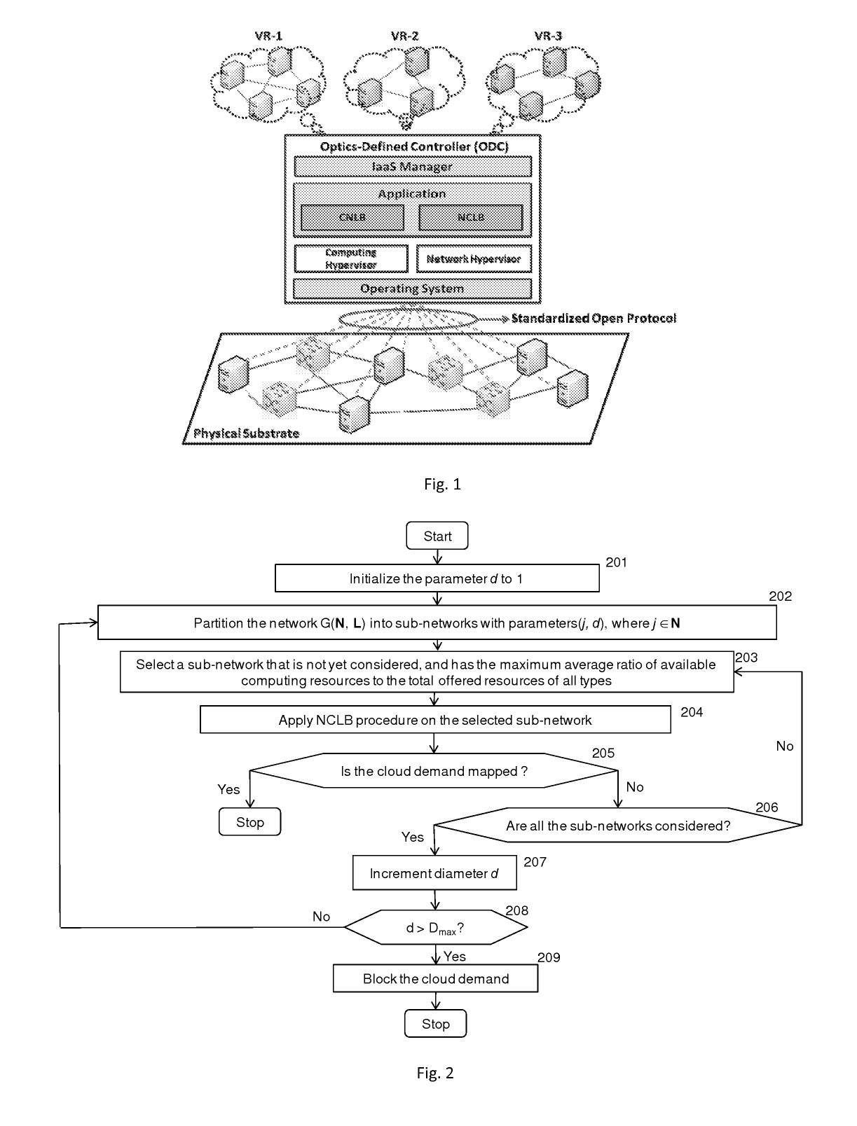

### DETAILED DESCRIPTION

The present invention is directed to a method, namely network depth Limited network followed by compute load balancing (ND-NCLB) that can embed more cloud demands than existing solutions.

The invention partitions the physical network G(N, L) into sub-networks with parameter (j, d), where j∈N represents a center node, and d represents the depth of a sub-network. Network depth is defined as the maximum number of hops from the center node j to any node in the network. A sub-network is formed by considering interconnection of all the network nodes those are at most d hops (sub-network depth) away from the center node j. The procedure partitions the physical network into the maximum |N| sub-networks.

In the next step, the procedure selects a sub-network G″(A, P) that has the maximum average ratio of available resources to the total offered resources of all types, where A denotes a set of physical nodes, and P denotes a set of physical links. Over the selected sub-network, the procedure applies NCLB procedure [IR-NCLB] as follows.

In the NCLB procedure, to reduce the management complexity, the spectrum is slotted at the granularity of q GHz. A slot is referred to as a wavelength slot. Thus, spectrum can be represented by a set of consecutive wavelength slots, and among them, the first wavelength slot index is denoted as the wavelength of an optical channel. Thus, the network consists of total ceiling(T/q) wavelength slots [Note: ceiling(.) and floor(.) indicate ceiling and floor mathematical operations respectively over the value confined within a bracket]. The state of each wavelength slot is represented by a binary variable; ‘1’ indicated that the wavelength slot is available and ‘0’ indicates that the wavelength slot is occupied. The spectrum state of a fiber is represented by a binary vector that is referred to as a bit-map of a fiber.

The procedure pre-calculates up to k-shortest routes between each pair of nodes, where k≦|N|. The procedure first maps virtual links (VLs) over physical links (PLs) of sub-network G″(A, P), where A⊂N is a set of physical nodes and P⊂L is a set of physical links, while performing load balancing over network resources. The procedure first arranges the VLs of the cloud demand in a descending order of the requested line rates. A VL is selected from this ordered list one-by-one and mapped on the sub-network G″. For the picked VL, the procedure finds a set of PNs, Gj, within the sub-network G″ for each unmapped VN j of the VL such that all PNs within a set has at least the required number of each type of resources requested by the VN j. If the set Gⱼ of any unmapped VN j is empty, then the procedure cannot map VN over any of the PNs within sub-network G″, and selects the next sub-network that is not yet considered. If all the sub-networks are considered with parameters (j, d), where j∈N, the procedure increments the depth d. If the new depth d is smaller than or equal to the depth of the given network G(N, L), Dₘₐₓ, then the procedure reparations the given network into sub-networks with parameters (j, d), otherwise the procedure blocks the cloud demand and terminates.

On the other hand, if the sets Gⱼ of all unmapped VNs j are non-empty, then the procedure performs specific actions based on how many VNs of the selected VL are unmapped. If both the VNs of the selected VL are unmapped, then the procedure considers potential mapping of the VL over k-shortest routes connecting each combination of physical nodes (r, t), where r^{∈}Gᵢ and t^{∈}Gⱼ, r≠t, and finds a potential set of modulation formats Mᵣₜ^{k} for each of the potential mapping on route k between physical nodes r and t based on the reachability constraint. On the other hand, if one of the VNs is already mapped to some of the PN, and the remaining VN is not yet mapped, then the procedure considers potential mapping of the VL over k-shortest routes connecting each combination of physical nodes (r, t), where r is the already mapped VN and t^{∈}Gⱼ is the unmapped VN, where r≠t, and finds a potential set of modulation formats Mᵣₜ^{k} for each of the potential mapping on route k between physical nodes r and t based on the reachability constraint. On the other hand, if both of the VNs of the VL are already mapped, then the procedure considers potential mapping of the VL over k-shortest routes between nodes (r, t), where VNs i and j are already mapped to PNs r and t, and finds a potential set of modulation formats Mᵣₜ^{k} based on the reachability constraint. In the next step, the procedure finds a bit-map of each of the k-shortest potential routes connecting each combination of physical nodes (r, t). A bit-map of a route is determined by performing bit-wise logical end operations on the bit-maps of all physical links along the route.

The procedure also determines the required spectrum Sᵣₜ^{km}=Ceiling (lᵢⱼ/Zₘ) for each modulation format m^{∈}Mᵣₜ^{k}. In the next step, the procedure finds the probability of mapping the VL over a potential route k connecting PNs r and t using modulation format m^{∈}Mᵣₜ^{k}, denoted as Pᵣₜ^{km}. Pᵣₜ^{km} is the ratio of the number of wavelength slots starting from which ceiling(Sᵣₜ^{km}/q) consecutive wavelength slots are available for a modulation format m on the bit-map of a route k to the total number possible wavelength slots [floor(T/q)-ceiling(Sᵣₜ^{km}/q))+1] starting from which ceiling(Sᵣₜ^{km}/q) consecutive wavelength slots can be mapped. After evaluating combinations of all potential routes and modulation formats, the procedure selects a route and modulation format those maximize Pᵣₜ^{km}. If Pᵣₜ^{k} is 0, then the procedure cannot map the VL on any of the routes within sub-network G″ using any of the modulation formats. In this case, the procedure releases all the pre-allocated resources, and selects the next sub-network that is not yet considered. If all the sub-networks are considered with parameters (j, d), where j∈N, the procedure increments the depth d. If the new depth d is smaller than or equal to the depth of the given network G(N, L), Dₘₐₓ, then the procedure reparations the given network into sub-networks with parameters (j, d), otherwise the procedure blocks the cloud demand and terminates. On the other hand, if is Pᵣₜ^{km} nonzero, then the procedure finds the lowest wavelength slot starting from which ceiling(Sᵣₜ^{km}/q) consecutive wavelength slots are available for the selected modulation format m and route k, and provisions the VL at the found wavelength slots on the selected route k and modulation format m between r and t PNs. Once the VL is mapped, the procedure maps the VNs at the both ends of the VL. The resources related to VN i are assigned to the PN r if r is not already mapped. Similarly, the resources related to VN j are assigned to the PN t if t is not already mapped. Finally, the procedure checks whether all VLs are provisioned or not. If at least one of the VLs is not yet provisioned, then the procedure repeats the procedure until all VLs are provisioned in the same sub-network G″. If all the VLs are mapped in the sub-network, then the process is terminated.

The ND-NCLB method is described in terms of the flow chart shown in FIG. 2.

At step 201, the method initializes the depth d of a sub-network to be 1.

Next at step 202, the method partitions the given network G(N, L) into sub-networks with parameter (j, d), where j∈N represents the center node of a sub-network, and d represents the depth of a sub-network. Thus, all nodes within these sub-networks are at most d hops away from the center node j. The procedure generates total |N| sub-networks.

Next at step 203, the method selects a sub-network that is not yet considered, and has the maximum average ratio of the available computing resources to the total offered resources for all types. This operation balances the occupied and available computing resources over the physical network.

At step 204, the method applies the NCLB method to map the virtual nodes and virtual links of the cloud demand over the selected sub-network G″.

Then at step 205, method checks weather the cloud demand is mapped or not. If the cloud demand is mapped in the selected sub-network G″, then the procedure terminates, otherwise the procedure follows Step 206.

At step 206, the method checks weather all sub-networks with parameters (j, d) considered or not. If at least one of the sub-networks is not yet considered, then the procedure follows Step 203. If all sub-networks are considered with parameters (j, d), then the procedure follows Step 207.

At step 207, the method increments the depth d.

At step 208, the method checks weather the new depth d is larger than the maximum depth Dₘₐₓ of the given network G(N, L), where Dₘₐₓ is the maximum hop count of the shortest route between any pair of nodes in the given network G. If the new depth d is smaller than Dₘₐₓ, then the procedure follows Step 202, otherwise the procedure follows Step 209.

At step 209, the method blocks the cloud demand, and terminates.

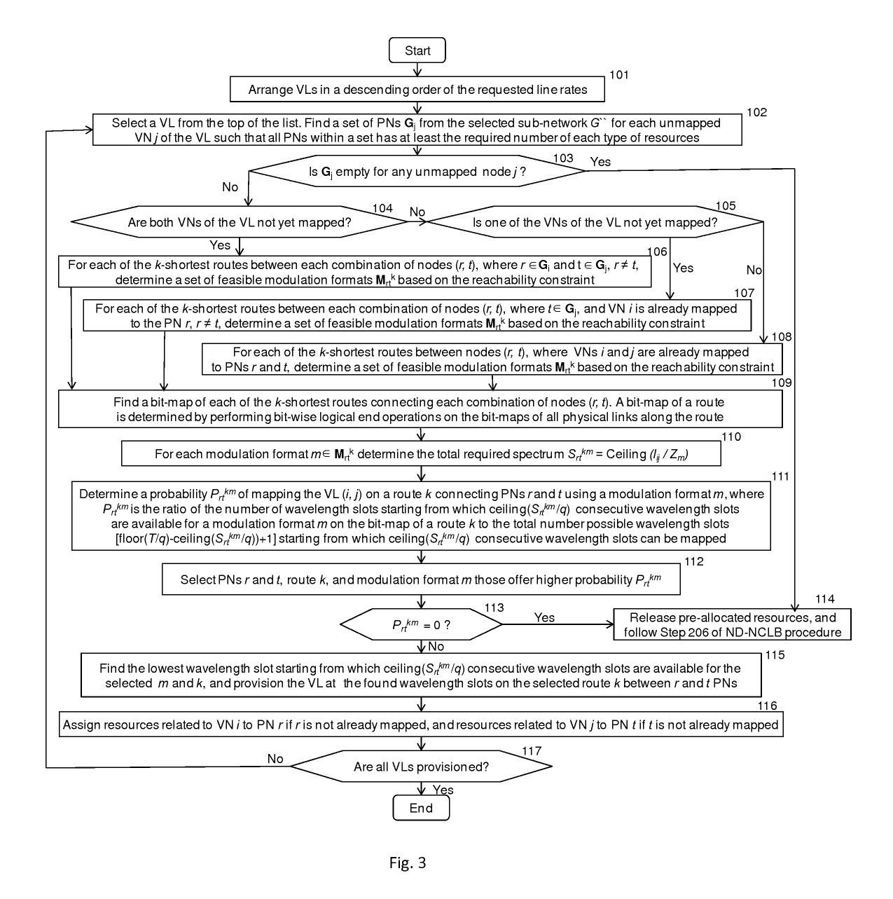

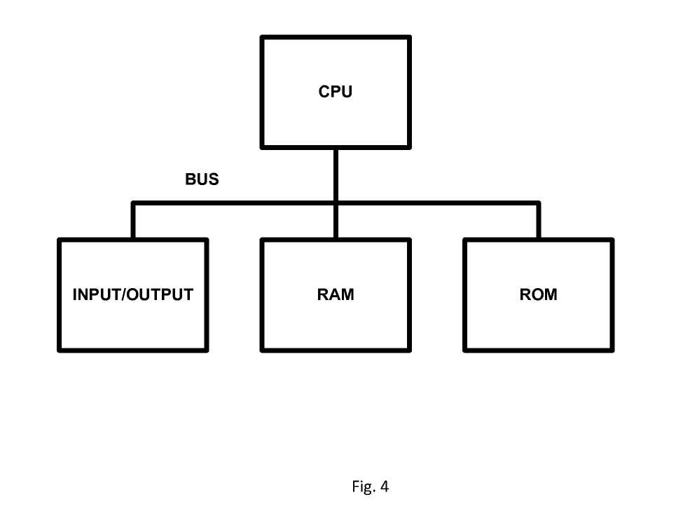

The NCLB aspect of the invention is described in terms of the flowchart shown in FIG. 3.

At step 101, the NLCB aspect of the invention arranges VLs in a descending order of the requested line rates.

At step 102, the method selects a VL from the top of the list, and finds a set of PNs Gⱼ from the selected sub-network G″ for each unmapped VN j of the VL such that all PNs within a set has at least the required number of each type of resources.

At step 103, the method checks whether Gⱼ is empty. If Gⱼ is empty, then the procedure follows Step 114, otherwise the procedure follows Step 104.

At step 104, the method checks whether both VNs of the VL are not yet mapped. If both the VNs of the VL are not yet mapped, then the procedure follows Step 106. On the other hand, if at least one of the VNs is already mapped, then the procedure follows Step 105.

At step 105, the method checks whether one of the VNs is already mapped while the other is not yet mapped. If this is true, then the procedure follows Step 107, otherwise, the procedure follows Step 108.

At step 106: For each of the k-shortest routes between each combination of nodes (r, t), where r^{∈}Gᵢ and t^{∈}Gⱼ, r≠t, the procedure determines a set of feasible modulation formats Mᵣₜ^{k} based on the reachability constraint.

At step 107: For each of the k-shortest routes between each combination of nodes (r, t), where t^{∈}Gⱼ, and VN i is already mapped to the PN r, r≠t, the procedure determines a set of feasible modulation formats Mᵣₜ^{k} based on the reachability constraint.

At step 108: For each of the k-shortest routes between nodes (r, t), where VNs i and j are already mapped to PNs r and t, the procedure determines a set of feasible modulation formats Mᵣₜ^{k} based on the reachability constraint.

At step 109, the method finds a bit-map of each of the k-shortest routes connecting each combination of nodes (r, t). A bit-map of a route is determined by performing bit-wise logical end operations on the bit-maps of all physical links along the route.

At step 110, the method determines the total required spectrum Sᵣₜ^{km}=Ceiling (lᵢⱼ/Zₘ) for each modulation format m ^{∈}Mᵣₜ^{k}.

At step 111, the method determines a probability Pᵣₜ^{km} of mapping the VL (i, j) on a route k connecting PNs r and t using a modulation format m, where Pᵣₜ^{km} is the ratio of the number of wavelength slots starting from which ceiling(Sᵣₜ^{km}/q) consecutive wavelength slots are available for a modulation format m on the bit-map of a route k to the total number possible wavelength slots [floor(T/q)-ceiling(Sᵣₜ^{km}/q))+1] starting from which ceiling(Sᵣₜ^{km}/q) consecutive wavelength slots can be mapped.

At step 112, the method selects PNs r and t, route k, and modulation format m those offer higher probability Pᵣₜ^{km}.

At step 113, the method checks whether Pᵣₜ^{km} is 0. If it is, then the procedure follows Step 114, otherwise it follows Step 115.

At step 114, the method releases all the pre-allocated node and spectrum resources, and follows Step 206 of the ND-NCLB procedure.

At step 115, the method finds the lowest wavelength slot starting from which ceiling(Sᵣₜ^{km}/q) consecutive wavelength slots are available for the selected m and k, and provision the VL at the found wavelength slots on the selected route k between r and t PNs.

At step 116, the method assigns resources related to VN i to PN r if r is not already mapped, and resources related to VN j to PN t if t is not already mapped.

At step 117, the method checks weather all VLs are mapped. If at least on the VLs is not yet mapped, then the procedure repeats step 102, otherwise it terminates.

From the foregoing, it can be appreciated that the present invention provides an efficient procedure, ND-NCLB, which partitions the physical network into many sub-networks, and limits the mapping of cloud demands within one of the sub-networks to avoid over provisioning of resources. The invention can embed more cloud demands than the existing solutions. The invention is applicable in the optical control plane, such as Path Computation Element (PCE) and as an application in a software-defined controller.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

1. A computer implemented method for embedding cloud demands over a software defined flexible grid optical transport network comprising the steps of:
partitioning a software defined flexible grid optical transport network into multiple sub-networks; a sub-network being selected among a set of the sub-networks with a depth d in a descending order of a maximum average ratio of available computing resources to a total offered resources in the network, the network depth being a maximum number of hops from a center node to any node in the network,
mapping a cloud demand over of the sub-networks using as load balancing that slots spectrum in the network into wavelength slots for reducing complexity of the mapping, and
increasing network depth d to increase a sub-network size until the cloud demand is successfully provisioned over the sub-network.

2. The method of claim 2, wherein the partitioning comprises parameters representing a center node and a depth of the sub-network, the sub-network being formed responsive to interconnection of all nodes in the network that are at most sub-network depth hops away from the center node, the partitioning resulting in a maximum number of sub-networks.

3. The method of claim 1, wherein the partitioning comprises partitioning the physical network G(N, L) into sub-networks with parameter (j, d), where j∈N represents a center node, and d represents the depth of a sub-network., the network depth being a maximum number of hops from the center node j to any node in the network, the sub-network being formed by considering an interconnection of all the network nodes those that are at most d hops sub-network depth away from the center node j, the physical network being partitioned into a maximum |N| sub-networks

4. The method of claim 1, wherein the mapping step comprises limiting the mapping of the cloud demand within a sub-network to avoid over-provisioning of network resources enabling a probability of blocking due by network resources to be reduced and more cloud demands can be embedded in the network.

5. The method of claim 1, wherein the increasing step comprises increasing the depth d of a sub-network if the cloud demand cannot be embedded in any sub-network with depth d.

6. The method of claim 1, wherein the load balancing comprises the spectrum being represented by a set of consecutive wavelength slots, and among them, a first wavelength slot index being denoted as the wavelength of an optical channel, the network consisting of a total ceiling(T/q) wavelength.

7. The method of claim 1, wherein the load balancing comprises pre-calculating up to k-shortest routes between each pair of nodes, where k≦|N|, first mapping virtual links (VLs) over physical links (PLs) of sub-network G″(A, P), where A∈N is a set of physical nodes and P ⊂L is a set of physical links, while performing load balancing over network resources.

8. The method of claim 1, wherein the load balancing comprises first arranging virtual links VLs of the cloud demand in a descending order of requested line rates, a virtual link VL being selected from this ordered list one-by-one and mapped on the sub-network G″, for a selected VL, there is a finding of a set of physical nodes PNs, Gⱼ, within the sub-network G″ for each unmapped virtual node VN j of the VL such that all PNs within a set has at least the required number of each type of resources requested by the VN j.

9. A non-transitory storage medium configured with instructions to be implemented by a computer for carrying out the following steps:
partitioning a software defined flexible grid optical transport network into multiple sub-networks; a sub-network being selected among a set of the sub-networks with a depth d in a descending order of a maximum average ratio of available computing resources to a total offered resources in the network, the network depth being a maximum number of hops from a center node to any node in the network,
mapping a cloud demand over of the sub-networks using as load balancing that slots spectrum in the network into wavelength slots for reducing complexity of the mapping; and
increasing network depth d to increase a sub-network size until the cloud demand is successfully provisioned over the sub-network.

10. The storage medium of claim 9, wherein the partitioning comprises parameters representing a center node and a depth of the sub-network, the sub-network being formed responsive to interconnection of all nodes in the network that are at most sub-network depth hops away from the center node, the partitioning resulting in a maximum number of sub-networks.

11. The storage medium of claim 9, wherein the partitioning comprises partitioning the physical network G(N, L) into sub-networks with parameter (j, d), where j∈N represents a center node, and d represents the depth of a sub-network., the network depth being a maximum number of hops from the center node j to any node in the network, the sub-network being formed by considering an interconnection of all the network nodes those that are at most d hops sub-network depth away from the center node j, the physical network being partitioned into a maximum |N| sub-networks

12. The storage medium of claim 9, wherein the mapping step comprises limiting the mapping of the cloud demand within a sub-network to avoid over-provisioning of network resources enabling a probability of blocking due by network resources to be reduced and more cloud demands can be embedded in the network.

13. The storage medium of claim 9, wherein the increasing step comprises increasing the depth d of a sub-network if the cloud demand cannot be embedded in any sub-network with depth d.

14. The storage medium of claim 9, wherein the load balancing comprises the spectrum being represented by a set of consecutive wavelength slots, and among them, a first wavelength slot index being denoted as the wavelength of an optical channel, the network consisting of a total ceiling(T/q) wavelength.

15. The storage medium of claim 9, wherein the load balancing comprises pre-calculating up to k-shortest routes between each pair of nodes, where k≦|N|, first mapping virtual links (VLs) over physical links (PLs) of sub-network G″(A, P), where A⊂N is a set of physical nodes and P⊂L is a set of physical links, while performing load balancing over network resources.

16. The storage medium of claim 9, wherein the load balancing comprises first arranging virtual links VLs of the cloud demand in a descending order of requested line rates, a virtual link VL being selected from this ordered list one-by-one and mapped on the sub-network G″, for a selected VL, there is a finding of a set of physical nodes PNs, Gⱼ, within the sub-network G″ for each unmapped virtual node VN j of the VL such that all PNs within a set has at least the required number of each type of resources requested by the VN j.

17. A system for a computer implemented method for embedding cloud demands over a software defined flexible grid optical transport network comprising the steps of:
partitioning a software defined flexible grid optical transport network into multiple sub-networks; a sub-network being selected among a set of the sub-networks with a depth d in a descending order of a maximum average ratio of available computing resources to a total offered resources in the network, the network depth being a maximum number of hops from a center node to any node in the network,
mapping a cloud demand over of the sub-networks using as load balancing that slots spectrum in the network into wavelength slots for reducing complexity of the mapping; and
increasing network depth d to increase a sub-network size until the cloud demand is successfully provisioned over the sub-network.

18. The system of claim 17, wherein the partitioning comprises parameters representing a center node and a depth of the sub-network, the sub-network being formed responsive to interconnection of all nodes in the network that are at most sub-network depth hops away from the center node, the partitioning resulting in a maximum number of sub-networks.

19. The system of claim 17, wherein the partitioning comprises partitioning the physical network G(N, L) into sub-networks with parameter (j, d), where j∈N represents a center node, and d represents the depth of a sub-network., the network depth being a maximum number of hops from the center node j to any node in the network, the sub-network being formed by considering an interconnection of all the network nodes those that are at most d hops sub-network depth away from the center node j, the physical network being partitioned into a maximum |N| sub-networks

20. The system of claim 17, wherein the mapping step comprises limiting the mapping of the cloud demand within a sub-network to avoid over-provisioning of network resources enabling a probability of blocking due by network resources to be reduced and more cloud demands can be embedded in the network.
